(19) United States
(12) Patent Application Publication
(10) Pub. No.: US 2012/0099943 A1
(43) Pub. Date: Apr. 26, 2012

(54) Captive fastener

(75) Inventor: Ming-Chung Chiu, Keelung City (TW)

(73) Assignee: HANWIT PRECISION INDUSTRIES LTD., Sijhih City (TW)

(21) Appl. No.: 12/926,062

(22) Filed: Oct. 25, 2010

(51) Int. Cl. F16B 39/24

(52) U.S. Cl. 411/347

(57) ABSTRACT

A captive fastener includes a mounting base member bonded to a first panel frame, a locking shank loaded with a spring member and axially movably mounted in the mounting base member hole for engaging into a mounting through hole of a second panel frame to detachably lock the second panel frame to the first panel frame, and a driving member, which is coated with a color index coating for identification and connected to the locking shank after bonding the mounting base member to the first panel frame and operable to move the locking shank between a locking position where the first panel frame and the second panel frame are locked and an unlocking position where the first panel frame is detachable from the second panel frame.

### BACKGROUND OF THE INVENTION

1. Field of the Invention

The present invention relates to fastener means for joining two metal panel frames and more particularly, to a captive fastener, which has the locking shank operating driving member thereof to be fastened to the locking shank after bonding of the mounting base member thereof to a first panel frame so that the color index coating of the driving member is kept intact during reflow soldering of the mounting base to the first panel frame.

2. Description of the Related Art

When fastening panel frames together, a fastening screw assembly formed of a knob, a barrel and a screw is usually used. During installation, the screw and the barrel are secured to the first panel frame, and then the knob is rotated to drive the screw into the second panel frame, and then a hand tool is used to fasten tight the screw, affixing the first and second panel frames together. This design of fastening screw assembly can be used in a machine tool to join panel frames together. In a machine tool where panel frames are to be fastened together are commonly at the locations of the power drive and speed-adjustment unit. Further, the power drive and speed-adjustment unit of a machine tool are commonly arranged inside a housing. When the power drive or speed-adjustment unit fails, or when an adjustment of the speed of the power drive or speed-adjustment unit is necessary, the panel frames must be unlocked. When unlocking the panel frames, the component parts of the fastening screw assemblies may fall from the panel frames and missed accidentally, affecting further re-installation operation.

To facilitate detachable installation of panel frames and to avoid missing of component parts, captive screws are developed. Conventional captive screws are commonly formed of a cap member, a screw, a spring member and a mounting barrel. During application, the mounting barrel is affixed to a mounting through hole on a first panel frame to hold the screw, the spring member and the cap member in place, allowing the screw to be detachably driven into a mounting screw hole on a second panel frame to detachably lock the second panel frame to the first panel frame. These captive screws prevent falling of the component parts from the first panel frame after separation of the first panel frame from the second panel frame. Other captive fasteners are known for detachably fastening panel frames together. These captive fasteners use a locking shank for engaging into a mounting screw hole on a second panel frame to detachably lock the second panel frame to the first panel frame, and a drawbar or knob operable by a person to move the locking shank axially between a locking position and an unlocking position. The drawbar or knob may be coated with a color index coating for identification and for protection against corrosion and moisture. However, when bonding the mounting barrel of a captive screw or captive fastener to a panel frame by reflow soldering, the high temperature in the reflow oven may cause the color index coasting to face or to drop. In actual practice, the known prior art designs have the drawbacks as follows:

1. When a captive screw or captive fastener is delivered with a panel frame into reflow oven for reflow soldering, the high temperature in the reflow oven will cause the color index coasting of the captive screw or captive fastener to face or to drop, loosening or weakening the corrosion-resistant and moisture-resistant properties.
2. When all the component parts of a captive screw or captive fastener are delivered with a panel frame into reflow oven for reflow soldering, the captive screw or captive fastener may be forced to loose its balance and to fall out of position, resulting in a bonding failure or inaccurate bonding.

Therefore, it is desirable to provide a captive fastener, which avoids fading or damage of the color index coating during its high temperature bonding to a panel frame.

### SUMMARY OF THE INVENTION

The present invention has been accomplished under the circumstances in view. It is therefore an object of the present invention to provide a captive fastener design, which facilitates accurate bonding of the mounting base member thereof to a panel frame and avoids fading of the color index coating thereof or damage to the color index coating during a high temperature bonding.

To achieve these and other objects of the present invention, a captive fastener comprises a mounting base member, a cap, a spring member, a locking shank and a driving member. The mounting base member is bonded to a mounting through hole of a first panel frame, comprising a chamber, a positioning portion downwardly extended from the bottom side thereof for insertion into the mounting through hole of the first panel frame, an axle hole axially extending through the positioning portion in communication between the chamber and the atmosphere, a shoulder defined between the chamber and the axle hole and a locating portion disposed at the top side thereof. The cap is mounted in the locating portion of the mounting base member, having a center hole. The locking shank is axially movably mounted in the mounting base member and adapted for engaging into a mounting through hole of the second panel frame to lock the second panel frame to the first panel frame, comprising a shank body inserted through the center hole of the cap and suspending in the chamber of the mounting base member, an engagement portion axially extended from one end of the shank body and inserted through the axle hole of the mounting base member for engaging into the mounting through hole of the second panel frame to lock the second panel frame to the first panel frame, and a stop flange extending around the periphery thereof between the shank body and the engagement portion and stoppable at the shoulder inside the mounting base member. The spring member is sleeved onto the shank body of the locking shank in the chamber and stopped between the stop flange of the locking shank and the cap for returning the locking shank after the locking shank having moved. The driving member is operable to move the locking shank axially relative to the mounting base member between a locking position and an unlocking position, comprising a connecting portion disposed at one side thereof for connection to the shank body of the locking shank. Further, the driving member is coated with a layer of color index coating for identification and for protection against corrosion and moisture. The driving member is to be fastened to the locking shank after bonding the mounting base member to the first panel frame. Thus, the color index coating of the driving member is kept intact when bonding the mounting base member to the first panel frame under a high temperature environment.

Further, the locating portion of the mounting base member can be a recessed structure for accommodating the cap. Alternatively, the locating portion of the mounting base member can be a protruded design, and the cap can be made having a recessed coupling portion located on the bottom side around the center hole thereof and press-fitted onto the protruded design of the locating portion of the mounting base member.

### BRIEF DESCRIPTION OF THE DRAWINGS

FIG. 1 is an elevational view of a captive fastener in accordance with a first embodiment of the present invention.

FIG. 2 is an exploded view of the captive fastener in accordance with the first embodiment of the present invention.

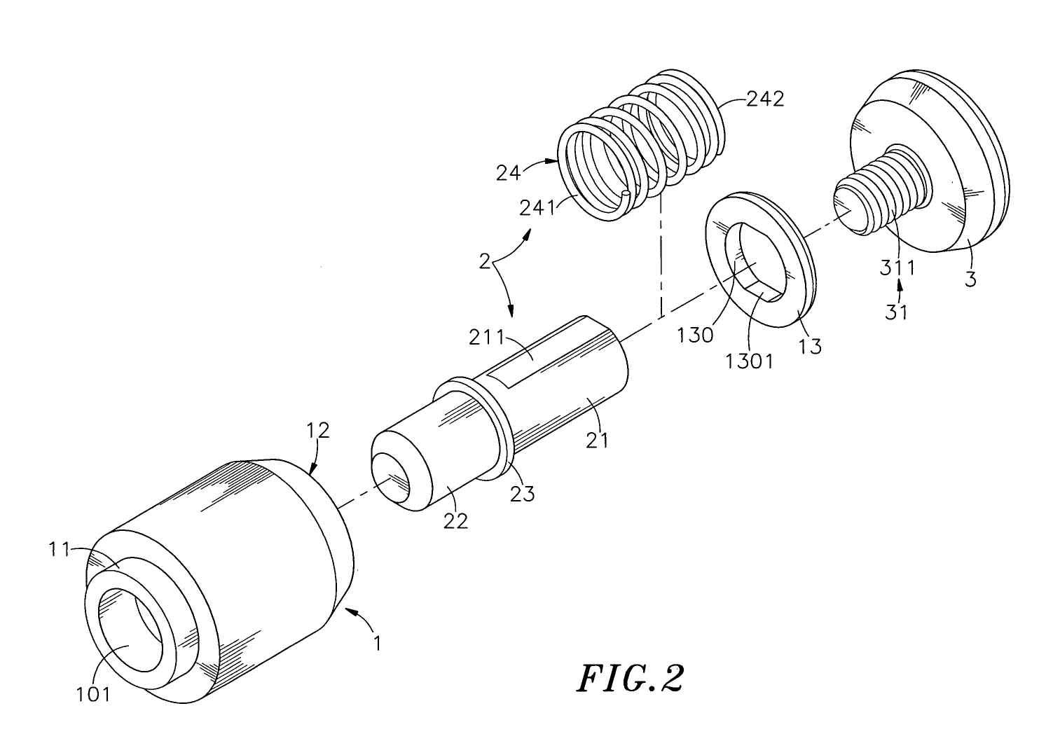

FIG. 3 corresponds to FIG. 2 when viewed from another angle.

FIG. 4 is a schematic sectional side view of the first embodiment of the present invention before bonding of the mounting base member to a first panel frame.

FIG. 5 is a schematic sectional side view of the first embodiment of the present invention, showing the captive fastener installed in the first panel frame before installation in a second panel frame.

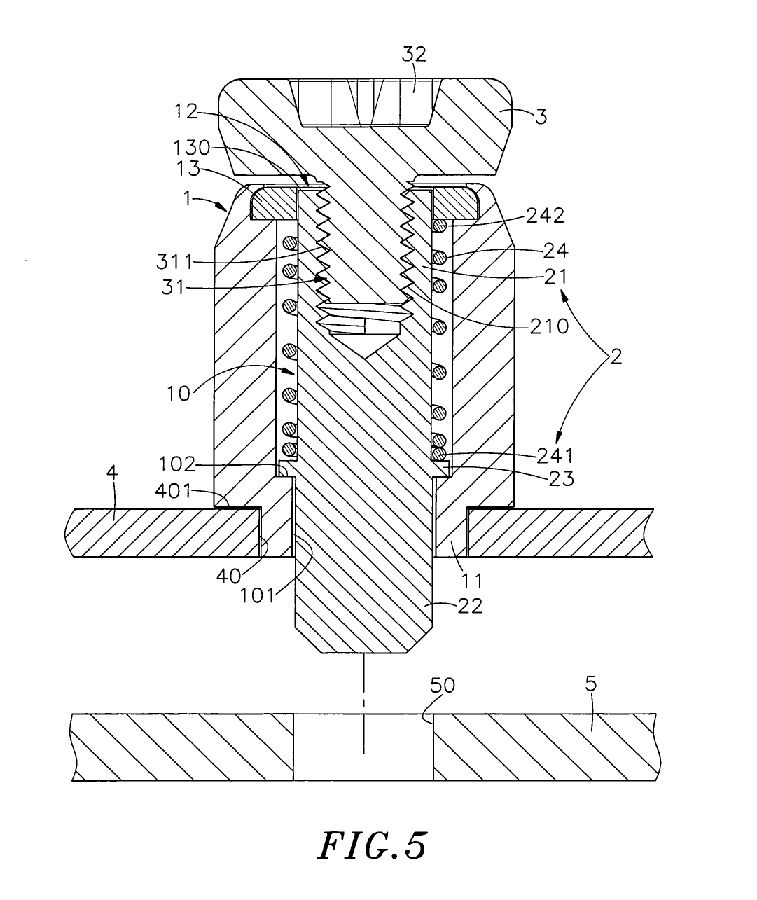

FIG. 6 corresponds to FIG. 5, illustrating the first panel frame attached to the second panel frame and the engagement portion of the locking shank engaged into the mounting through hole of the second panel frame.

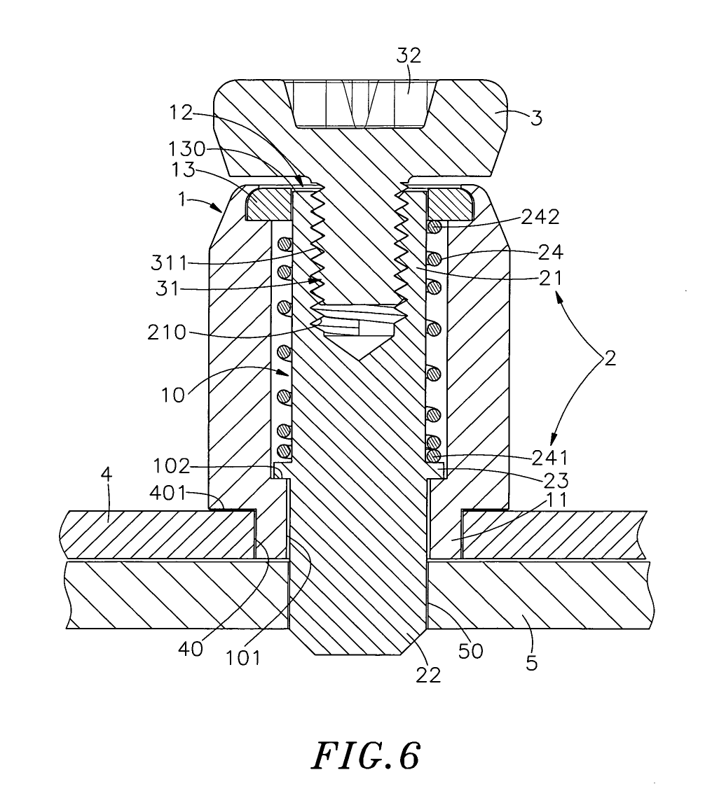

FIG. 7 is an exploded view of a captive fastener in accordance with a second embodiment of the present invention.

### DETAILED DESCRIPTION OF THE PREFERRED EMBODIMENT

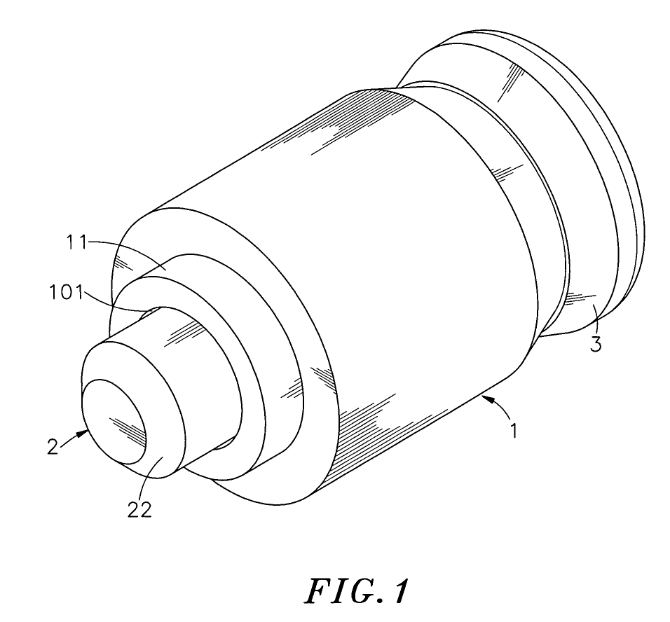

Referring to FIGS. 1˜3, a captive fastener in accordance with the present invention is shown comprising a mounting base member 1, a locking shank 2 and a driving member 3.

The mounting base member 1 comprises a chamber 10, a positioning portion 11 downwardly extended from its one side, namely, the bottom side, an axle hole 101 axially extending through the positioning portion 11 in communication between the chamber 10 and the atmosphere, a shoulder 102 defined between the chamber 10 and the axle hole 101 and a locating portion 12 disposed at its other side, namely, the top side. Further, a cap 13 is mounted in the locating portion 12, having a center hole 130 slightly smaller than the inner diameter of the chamber 10.

The locking shank 2 comprises a shank body 21, an engagement portion 22 axially extended from one end, namely, the bottom end of the shank body 21, a stop flange 23 extending around the periphery thereof between the shank body 21 and the engagement portion 22. Further, an elastic member, for example, a spring member 24 is sleeved onto the shank body 21 of the locking shank 2 and received inside the chamber 10, having its one end 241 stopped against the stop flange 23 and its other end 242 stopped against the cap 13.

The driving member 3 comprises a connecting portion 31 disposed at its one side and a driving portion 32 disposed at its other side. Further, the driving member 3 is coated (by spray-painting or plating technique) or marked with a color index (in red, blue, yellow, or any other color) for identification.

During installation, insert the locking shank 2 through the locating portion 12 into the chamber 10 and then the axle hole 101 of the mounting base member 1 to stop the stop flange 23 of the locking shank 2 at the shoulder 102, and then sleeve the spring member 24 onto the shank body 21 of the locking shank 2 in the chamber 10, and then fasten the cap 13 to the inside of the locating portion 12 to let the top end of the engagement portion 22 of the locking shank 2 be received in the center hole 130 of the cap 13 and the two opposite ends 241 and 242 of the spring member 24 be respectively stopped against the stop flange 23 and the cap 13, and then fasten the connecting portion 31 of the driving member 3 to the shank body 21 of the locking shank 2.

Further, the locating portion 12 is a recessed structure extending around the top side of the chamber 10 of the mounting base member 1 for receiving the cap 13. After insertion of the cap 13 into the locating portion 12 of the mounting base member 1, the cap 13 and the locating portion 12 are riveted together.

Further, the cap 13 has at least one flat plane 1301 on the inside edge of the center hole 130. Further, the shank body 21 of the locking shank 2 has at least one flat plane 211 matting the at least one flat plane 1301 of the cap 13. By means of the matting arrangement between the at least one flat plane 211 of the locking shank 2 and the at least one flat plane 1301 of the cap 13, the locking shank 2 is movable axially relative to the mounting base member 1 and the cap 13 but prohibited from rotation relative to the mounting base member 1 and the cap 13.

The locking shank 2 further comprises a screw hole 210 formed in the shank body 21. Further, the connecting portion 31 of the driving member 3 has an outer thread 311 spirally extending around the periphery thereof for threading into the screw hole 210 in the shank body 21 of the locking shank 2. Except the technique of connecting the driving member 3 to the shank body 21 of the locking shank 2 by means of a screw joint, any of a variety of other known techniques may be employed for the connection between the locking shank 2 and the driving member 3. For example, the shank body 21 of the locking shank 2 can be made having an axially extending pin hole; the connecting portion 31 of the driving member 3 can be embossed and then press-fitted into the pin hole on the shank body 21 of the locking shank 2. Alternatively, the shank body 21 of the locking shank 2 can be made having a mounting hole; the connecting portion 31 of the driving member 3 is configured for engaging into the mounting hole on the shank body 21 of the locking shank 2 tightly.

Further, the driving portion 32 of the driving member 3 can be a tool groove, for example, a keystone groove, crossed groove, hexagonal groove, or polygonal groove for the positioning of a keystone tip screwdriver, Phillips tip screwdriver, hexagonal wrench, open-end wrench, offset wrench, or ratchet wrench. Further, instead of the aforesaid keystone groove, crossed groove, hexagonal groove or key groove, a keystone rib, crossed rib, hexagonal rib or key rib may be made on and raised from the top wall of the driving member 3 to fit a respective matching wrench tool.

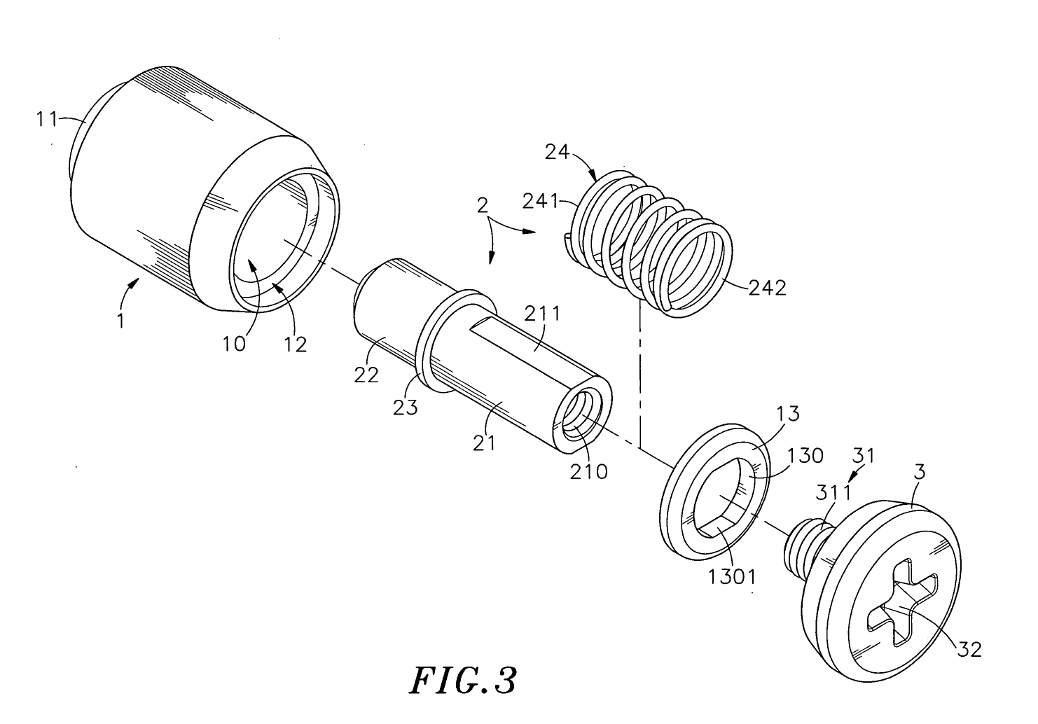

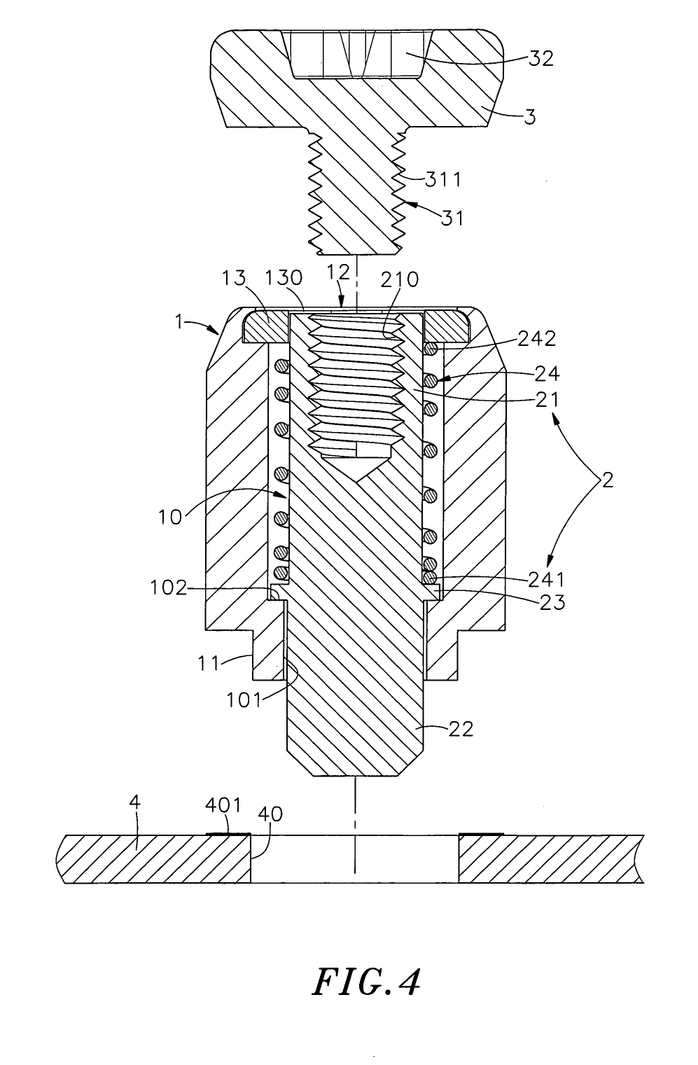

Referring to FIGS. 4˜6 and FIG. 3 again, during application of the captive fastener, insert the positioning portion 11 of the mounting base member 1 into a mounting through hole 40 of a first panel frame 4 and then fixedly secure the positioning portion 11 to the mounting through hole 40 of a first panel frame 4, and then insert the locking shank 2 into the mounting base member 1 and sleeve the spring member 24 onto the shank body 21 of the locking shank 2, and then fasten the cap 13 to the inside of the locating portion 12, and then fasten the connecting portion 31 of the driving member 3 to the shank body 21 of the locking shank 2. Because the mounting base member 1, the locking shank 2 and the driving member 3 are separately installed in a proper order, the color index coating of the driving member 3 will not be caused to fade or to drop by any other processing work. Further, the color index coating of the driving member 3 provides corrosion resistant and damp proof functions. After installation of the captive fastener in the first panel frame 4, the driving member 3 is operable to move the locking shank 2 up and down relative to the mounting base member 1 between a locking position and an unlocking position. Subject to the spring power of the spring member 24, the locking shank 2 is rapidly returned to its former position (the normal unlocking position) after released from the constraint.

When securing the first panel frame 4 to a second panel frame 5, attach the first panel frame 4 to the second panel frame 5 to keep the mounting through hole 40 of the first panel frame 4 in axial alignment with a corresponding mounting through hole 50 on the second panel frame 5, enabling the engagement portion 22 of the locking shank 2 to be engaged into the mounting through hole 50 of the second panel frame 5 to lock the first panel frame 4 to the second panel frame 5 together. When detaching the first panel frame 4 from the second panel frame 5, operate the driving member 3 to release the locking shank 2 from the mounting through hole 50 of the second panel frame 5, enabling the locking shank 2 to be rapidly returned to its normal unlocking position by the spring power of the spring member 24.

Further, the mounting through hole 50 of the second panel frame 5 can be a screw hole, and the engagement portion 22 of the locking shank 2 can be externally threaded for threading into the threaded mounting through hole 50 of the second panel frame 5.

Further, the positioning portion 11 of the mounting base member 1 can be fixedly fastened to the mounting through hole 40 of a first panel frame 4 by means of the application of an adhesive or reflow soldering, electric welding, spot welding or any of a variety of other bonding techniques. When a reflow soldering technique is employed, a solder material 401 (solder paste or solder balls) is applied to the top wall of the first panel frame 4 around the mounting through hole 40, and then the mounting base member 1 and the first panel frame 4 are put in a reflow oven for reflow soldering of the mounting base member 1 to the first panel frame 4. Because the driving member 3 is to be fastened to the locking shank 2 after installation of the mounting base member 1 with the locking shank 2 in the first panel frame 4, delivering the first panel frame 4 with the mounting base member 1 to the reflow oven does not cause the mounting base member 1 to lose its balance, and therefore the mounting base member 1 can be reflow-soldered to the mounting through hole 40 of the first panel frame 4 accurately in position.

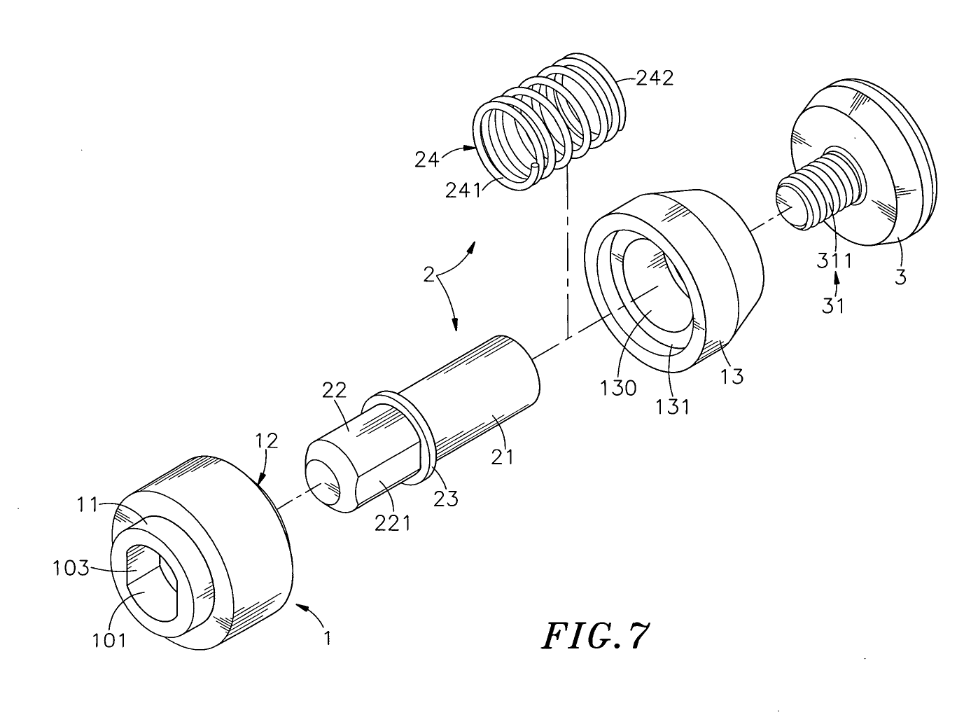

FIG. 7 illustrates an alternate form of the captive fastener. According to this alternate form, the locating portion 12 of the mounting base member 1 has a protruded design, and the cap 13 has a recessed coupling portion 131 located on the bottom side thereof around the center hole 130 and press-fitted onto the protruded locating portion 12 of the mounting base member 1. Further, the mounting base member 1 has the at least one flat plane 103 located on the inside edge of the axle hole 101; the engagement portion 22 of the locking shank 2 has at least one flat plane 221 matting the at least one flat plane 103 of the mounting base member 1. By means of the matting arrangement between the at least one flat plane 221 of the locking shank 2 and the at least one flat plane 103 of the mounting base member 1, the locking shank 2 is movable axially relative to the mounting base member 1 and the cap 13 but prohibited from rotation relative to the mounting base member 1.

As stated above, the invention provides a captive fastener, which comprises a mounting base member 1 having a chamber 10 and a positioning portion 11 and a locating portion 12 respectively disposed at the top and bottom sides of the chamber 10, a cap 13 mounted in the locating portion 12 and having a center hole 130, a locking shank 2 having an engagement portion 22 disposed at the bottom side and inserted through an axle hole 101 in the positioning portion 11 of the mounting base member 1 and a top shank body 21 suspending in the chamber 10, a spring member 24 sleeved onto the top shank body 21 suspending in the chamber 10 and stopped between a stop flange 23 around the periphery of the locking shank 2 and the cap 13, and a driving member 3 having a connecting portion 31 inserted through the center hole 130 of the cap 13 and fastened to the shank body 21 of the locking shank 2. The positioning portion 11 of the mounting base member 1 is inserted into a mounting through hole 40 on a first panel frame 4 and then the mounting base member 1 and the first panel frame 4 are bonded together by means of a reflow soldering process before installation of the driving member 3. Further, the driving member 3 is coated with a color index for identification. The color index coating also protects the driving member 3 against moisture and corrosion.

In conclusion, the captive fastener of the present invention has the following advantages and features:

1. After insertion of the locking shank 2 with the spring member 24 into the chamber 10 in the mounting base member 1 and fastening of the cap 13 to the locating portion 12 of the mounting base member 1, the mounting base member 1 and the locking shank 2 are delivered with the first panel frame 4 to a reflow oven for reflow soldering. After reflow soldering of the mounting base member 1 to the first panel frame 4, the driving member 3 is then fastened to the locking shank 2, and therefore the reflow soldering operation does not damage the color index costing of the driving member 3. After installation of the driving member 3, the color index costing of the driving member 3 is kept intact.
2. The driving member 3 is to be fastened to the locking shank 2 after installation of the mounting base member 1 with the locking shank 2 in the first panel frame 4, delivering the first panel frame 4 with the mounting base member 1 to the reflow oven does not cause the mounting base member 1 to lose its balance, and therefore the mounting base member 1 can be reflow-soldered to the mounting through hole 40 of the first panel frame 4 accurately in position.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A captive fastener installed in a mounting through hole of a first panel frame and detachably fastenable to a mounting through hole of a second panel frame to lock said second panel frame to said first panel frame, the captive fastener comprising:
a mounting base member bonded to the mounting through hole of said first panel frame, said mounting base member comprising a chamber, a positioning portion downwardly extended from a bottom side thereof for insertion into the mounting through hole of said first panel frame, an axle hole axially extending through said positioning portion in communication between said chamber and the atmosphere, a shoulder defined between said chamber and said axle hole and a locating portion disposed at a top side thereof;
a cap mounted in said locating portion of said mounting base member, said cap having a center hole, said center hole having a diameter smaller than the inner diameter of said chamber of said mounting base member;
a locking shank axially movably mounted in said mounting base member and adapted for engaging into the mounting through hole of said second panel frame to lock said second panel frame to said first panel frame, said locking shank comprising a shank body inserted through the center hole of said cap and suspending in said chamber of said mounting base member, an engagement portion axially extended from one end of said shank body and inserted through the axle hole of said mounting base member for engaging into the mounting through hole of said second panel frame to lock said second panel frame to said first panel frame, and a stop flange extending around the periphery thereof between said shank body and said engagement portion and stoppable at said shoulder inside said mounting base member;
a spring member mounted on said shank body of said locking shank in said chamber and adapted for returning said locking shank after said locking shank having been moved; and
a driving member operable to move said locking shank axially relative to said mounting base member between a locking position and an unlocking position, said driving member comprising a connecting portion disposed at one side thereof for connection to said shank body of said locking shank.

2. The captive fastener as claimed in claim 1, wherein said locating portion of said mounting base member is a recessed structure for accommodating said cap.

3. The captive fastener as claimed in claim 1, wherein said locating portion of said mounting base member has a protruded design; said cap comprises a recessed coupling portion located on a bottom side thereof around said center hole and press-fitted onto the protruded design of said locating portion of said mounting base member.

4. The captive fastener as claimed in claim 1, wherein said cap comprises at least one flat plane on the inside edge of said center hole; said locking shank comprises at least one flat plane located on said shank body and matting the at least one flat plane of said cap to prohibit rotation of said locking shank relative to said cap and said mounting base member.

5. The captive fastener as claimed in claim 1, wherein said mounting base member comprises at least one flat plane located on the inside edge of said axle hole; said locking shank comprises at least one flat plane located on the periphery of said engagement portion and matting the at least one flat plane of said mounting base member to prohibit rotation of said locking shank relative to said cap and said mounting base member.

6. The captive fastener as claimed in claim 1, wherein said locking shank further comprises a screw hole axially located on said shank body; said driving member further comprises an outer thread spirally extending around the periphery of said connecting portion for threading into the screw hole on said shank body of said locking shank.

7. The captive fastener as claimed in claim 1, wherein said locking shank further comprises a mounting hole axially located on said shank body; said connecting portion of said driving member is embossed and press-fitted into the pin hole on said shank body of said locking shank.

8. The captive fastener as claimed in claim 1, wherein said locking shank further comprises a mounting hole formed in said shank body; said connecting portion of said driving member is configured for engaging into the mounting hole on said shank body of said locking shank tightly.

9. The captive fastener as claimed in claim 1, wherein said locking shank further comprises an outer thread spirally extending around the periphery of said engagement portion for threading into the mounting through hole of said second panel frame.

10. The captive fastener as claimed in claim 1, wherein said spring member has one end thereof stopped against said stop flange of said locking shank and an opposite end thereof stopped against said cap.

11. The captive fastener as claimed in claim 1, wherein said driving member is coated with a layer of color index coating for identification.
